(19) United States
(12) Patent Application Publication
(10) Pub. No.: US 2002/0111420 A1
(43) Pub. Date: Aug. 15, 2002

(54) Underfill compositions

(75) Inventor: Konstantinos Papathomas, Endicott, NY (US)

Correspondence Address: Mark Levy, SALZMAN & LEVY, 19 Chenango St., Ste. 902, Binghamton, NY, 13901, US

(73) Assignee: INTERNATIONAL BUSINESS MACHINES CORPORATION, ARMONK, NY (US)

(21) Appl. No.: 09/781,631

(22) Filed: Feb. 12, 2001

(51) Int. Cl. C08J 3/00

(52) U.S. Cl. 524/588

(57) ABSTRACT

An underfill composition having improved mechanical properties resulting from the inclusion of a novel “core-shell” substance. The core-shell substance includes a fine powder, whose particles each having an outer shell with a T_{g} significantly above room temperature, and an inner core with a T_{g} significantly below room temperature. The shell substance often includes an acrylate or methacrylate and the core includes a wide range of materials, such as acrylates and silicone or butadiene-based rubbers.

### FIELD OF THE INVENTION

The present invention relates to encapsulating compositions and methods of applying them to electronic connections and, more particularly, to an improved underfill composition for use with the electrical connections between integrated circuit chips and their substrates.

### BACKGROUND OF THE INVENTION

Use of encapsulants for increasing the durability of connections and components in electronic circuits is well known. Encapsulants usually comprise polymer composites. In electrical connections between integrated circuit chips and their substrates, such encapsulants provide improved life and durability. The encapsulant is applied and then cured by baking into a rigid protective overlay.

The particular encapsulant formulation and method of this invention concerns Flip-Chip-Attach (FCA) encapsulation techniques. FCA encapsulants are currently used on ceramic substrates. The present invention includes the use of organic substrate materials. For organic substrates, the pre-cure viscosity of the encapsulant must be low, and the coefficient of thermal expansion (CTE) must be approximately three times that of ceramic materials (i.e., 20 ppm/degree C. vs. 6.5 ppm/degree C). The higher CTE causes a greater mismatch between chip and substrate, which requires that the encapsulant be tougher in withstanding thermal cycling.

Organic substrates pose additional problems for proper application of an encapsulant. Organic substrates absorb more moisture and are softer than ceramics. They bend during thermal stress, causing strains to the solder joints.

In a Direct-Chip-Attach-to-Module (DCAM) process, the solder joints are reflowed after encapsulation, making moisture resistance and adhesion of the encapsulant to the bottom of the chip crucial. Solder flows into the gap between the chip and the encapsulant if adhesion is lost. This, in turn, causes a short circuit. Such failure is also noted after five hundred cycles of thermocycling between −55° C. to 125° C.

It is also observed that reducing the curing times and temperatures of the encapsulant reduces the likelihood of preventing damage to other components on the card assembly.

There are usually two approaches for increasing the fracture toughness of an epoxy encapsulant: (a) decreasing the cross-linking density, and (b) adding soft, second-phase particles. Adding the soft, second-phase particles, however, often significantly increases the viscosity of the encapsulant, and decreases the glass transition temperature, T_{g}.

The present invention comprises materials that increase the toughness of the encapsulant up to fifty percent, without excessive change to the viscosity and glass transition temperature, T_{g}.

The material of the invention is a “core-shell” substance comprising a fine powder, whose particles each have a hard outer shell with a T_{g} significantly above room temperature, and a soft core with a T_{g} significantly below room temperature. The hard shell substance often comprises an acrylate or methacrylate, and the soft core can comprise a wide range of materials, such as acrylates and silicone or butadiene-based rubbers.

Organic materials that may be incorporated in the present invention include; epoxies, cyanate esters, bis-maleimides cyanate esters-epoxies polyimides, benzocyclobutenes, polysulfones, polyetherketones, and combinations thereof. Encapsulant may also consist of materials cited in U.S. Pat. No. 6,106,891 to Kuleska et al., assigned to IBM, which is incorporated herein by reference.

The underfill resin mixtures according to this invention may also contain accelerators, which are known to play an important role in curing epoxy resins. Tertiary amines or imidazoles are generally used. Suitable amines include, for example, tetramethylethylenediamine, dimethyloctylamine, dimethylaminoethanol, dimethylbenzylamine, 2,4,6-tris(dimethylaminomethyl)-phenol, N,N′-tetramethyl-diamino-diphenylmethane, N,N′-diamethylpiperazine, N-methylmorpholine, N-methylmorphomline, N-methylpiperidine, N-ethylpyrrolidine, 1,4-diazabicyclo(2,2,2)-octane and quinolines suitable imidazoles include, for example, 1-methylimidazole, 2-methylimidazole, 1,2-dimethylimidazole, 1,2,4,5-tetramethylimidazole, 2-ethyl-4-methylimidazole, 1-cyanoethyl-2-phenylimidazole and 1-(4,6-diamion-s-triazinyl-2-ethyl)-2-phenylimidaziole. The accelerators are added in a concentration of 0.01 to 2 wt %, preferably 0.05 to 1%, each based on the epoxy resin mixture.

Fillers may consist of silica, alumina, aluminum nitride, silicon nitride, silicon carbide, boron nitride, diamond powder, glass, all spherical or spheroidal in nature.

Substrates may comprise FR-4 epoxy and laminates based on epoxies, polyimides, cyanates, fluoropolymers, ceramic filled fluoropolymers, benzocyclobutenes, perfluorobutanes, polyphenylenesulfide, polysufones, polyetherimides, polyetherketones, polyphenylquinonxalines, polybenzoxazoles, and polyphenyl benzobisthiazole, combinations thereof and the like. In addition inorganic based substrates may be used in such ceramic based substrates.

### DISCUSSION OF RELATED ART

In U.S. Pat. No. 5,218,234, issued on Jun. 8, 1993 to Thompson et al for SEMICONDUCTOR DEVICE WITH CONTROLLED SPREAD POLYMERIC UNDERFILL, an underfill material is illustrated that fills the void or space between the flip-chip and the substrate. The underfill material is an epoxy resin that is loaded with inert fillers. The material is allowed to flow under the chip by adjusting the viscosity.

In U.S. Pat. No. 5,747,557, issued to Hanyu et al on May 5, 1998 for METHOD OF MANUFACTURING A CASTABLE EPOXY RESIN COMPOSITION COMPRISING ACRYLIC RUBBER PARTICLES PREDISPERSED IN AN ANHYDRIDE HARDENER, the acrylic rubber of the composition is in the form of a latex, whose skin is thermoplastic. The epoxy resin composition has a high crack resistance, a high heat resistance, and good mechanical characteristics.

In U.S. Pat. No. 4,822,545, issued to Kresge et al on Apr. 18, 1989 for METHOD FOR MAKING FREE-FLOWING COATED RUBBER PELLETS, a first polymer is blended with a second polymer with a crystalline or semi-crystalline melting point. The rubber pellet composition comprises an elastomer with a plastic skin.

### SUMMARY OF THE INVENTION

In accordance with the present invention, there is provided an encapsulant composition having improved mechanical properties resulting from the inclusion of a novel “core-shell” substance. The core-shell substance comprises a fine powder, whose particles each have a hard outer shell with a glass transition temperature, T_{g}, significantly above room temperature, and a soft core with a glass transition temperature, T_{g}, significantly below room temperature. The hard shell substance often comprises an acrylate or methacrylate, and the soft core comprises a wide range of materials, such as acrylates and silicone or butadiene-based rubbers. One such substance has the formulation by weight of a cycloaliphatic epoxy resin of between approximately 14 and 25 percent; a methyl-hexahydrophthalic anhydride of between approximately 14 and 25 percent; a first aliphatic polyol of between approximately 1 and 2 percent; a second aliphatic polyol of between approximately 0 and 1 percent; a reactive aromatic wetting agent of less than approximately 1 percent; 2-ethyl-4-methylimidazole of less than approximately 1 percent; a filler powder comprising silica (SiO₂) in a range of between approximately 40 and 60 percent; an organic dye of less than approximately 1 percent; a core-shell toughener of less than approximately 1 percent; and an epoxy silane, such as Dow-Corning Z6040, of between approximately 0.3 and 0.5 percent.

It is an object of this invention to provide an improved encapsulant composition for electrical connections, particularly in an FCA process.

It is another object of the invention to provide an encapsulant composition for electrical connections, that has improved mechanical properties.

It is a further object of this invention to provide an encapsulant composition for electrical connections, that is resistant to low temperature cracking.

### DESCRIPTION OF THE PREFERRED EMBODIMENT

Generally speaking, the invention features an underfill composition having improved mechanical properties resulting from the inclusion of a novel “core-shell” substance. The core-shell substance comprises a fine powder, whose particles each have a hard outer shell with a T_{g} significantly above room temperature, and a soft core with a T_{g} significantly below room temperature. The hard shell substance often comprises an acrylate or methacrylate, and the soft core comprises a wide range of materials, such as acrylates and silicone or butadiene-based rubbers.

In a preferred embodiment, the core shell material is added as approximately a one to ten weight percent of the epoxy resin along with an approximate one to thirty weight percent addition of a reactive thermoplastic polymer to reduce the cross-linking density.

The preferred composition for the underfill comprises by weight:

1. a cycloaliphatic epoxy resin of between approximately 14 and 25 percent;

2. a methyl-hexahydrophthalic anhydride of between approximately 14 and 25 percent;

3. a first aliphatic polyol of between approximately 1 and 2 percent;

4. a second aliphatic polyol of between approximately 0 and 1 percent;

5. a reactive aromatic wetting agent of less than approximately 1 percent;

6. 2-ethyl-4-methylimidazole of less than approximately 1 percent;

7. a filler powder comprising silica (SiO₂) in a range of between approximately 40 and 60 percent, the filler particle size being less than 25 microns;

8. an organic dye of less than approximately 1 percent;

9. a core-shell toughener of less than approximately 1 percent; and

10. an epoxy silane, such as Dow-Corning Z6040, of approximately 0.3 and 0.5 percent.

The anhydride and the core-shell particles (EXL 2300) are premixed for ten minutes at high shear at 80 to 100° C. The ERL-4221 resin and the silicon filler PQ-DP 4910 are also premixed.

The above composition, containing core shell, was tested for fracture toughness and cracking under thermocycling. The inventive core shell had a toughness of between approximately 1,350 and 1,450 psi-in^{½}, which compares with a top ranked, commercially available substance having a toughness range of between 850 to 950 psi-in^{½}.

The viscosity of the core shell composition increases slightly from 5,000 to 10,000 centipoises, but this is acceptable, because the encapsulant remains free-flowing under large DNP chips. The encapsulant flows under the chip by capillary action, when placed in contact with the edge of the joined chip at 50 to 70° C.

The inclusion of the silane component decreases the moisture uptake and increases its adhesion to silica-passivated chips. This is significant, because electrical shorting is reduced from the previous level on DCAM of 5 to 20 percent of C-4s, to zero. Microscopic examination revealed no gap, while all previously tested systems showed a gap.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A silica-filled encapsulant composition for electrical connections, comprising a “core-shell” substance including a fine powder, whose particles each have an outer shell with a glass transition temperature above room temperature, and a core with a glass transition temperature below room temperature.

2. The silica-filled encapsulant composition in accordance with claim 1, wherein silica fill is in a range of between approximately 40 and 60 percent by weight of the total encapsulant composition.

3. The silica-filled encapsulant composition in accordance with claim 1, wherein said encapsulant composition has a toughness of between approximately 800 and 2,500 psi-in^{½}.

4. The silica-filled encapsulant composition in accordance with claim 1, including a silane component.

5. The silica-filled encapsulant composition in accordance with claim 1, including at least one from the group of epoxy resins, polyimides, cyanide esters, and combinations thereof.

6. The silica-filled encapsulant composition in accordance with claim 5, wherein said epoxy resin comprises a cycloaliphatic epoxy resin and/or a glycidyl epoxide resin.

7. The silica-filled encapsulant composition in accordance with claim 5, wherein said epoxy resin comprises a cycloaliphatic epoxy resin in an approximate weight range of between 14 and 25 percent by weight of the total encapsulant composition.

8. The silica-filled encapsulant composition in accordance with claim 2, comprising a cycloaliphatic epoxy resin in an approximate weight range of between 14 and 25 percent by weight of the total encapsulant composition.

9. The silica-filled encapsulant composition in accordance with claim 2, comprising a cycloaliphatic epoxy resin and a methyl-hexa-hydrophthalic anhydride both respectively in an approximate weight range of between 14 and 25 percent by weight of the total encapsulant composition.

10. The silica-filled encapsulant composition in accordance with claim 9, including a silane component.

11. A silica-filled encapsulant composition for electrical connections, comprising:
a) silica fill in a range of approximately between 40 and 60 percent by weight of the total encapsulant composition; and
b) an epoxy resin and an anhydride both respectively in an approximate weight range of between 14 and 25 percent by weight of the total encapsulant composition.

12. The silica-filled encapsulant composition in accordance with claim 11, wherein said composition has a toughness of between approximately 800 and 2,500 psi-in^{½}.

13. The silica-filled encapsulant composition in accordance with claim 11, including a silane component.

14. The silica-filled encapsulant composition in accordance with claim 11, wherein said epoxy resin comprises a cycloaliphatic epoxy resin and/or a glycidyl epoxide resin.

15. The silica-filled encapsulant composition in accordance with claim 11, wherein said anhydride comprises a methyl-hexa-hydrophthalic anhydride.

16. A silica-filled encapsulant composition for electrical connections, comprising:
a) silica fill in a range of approximately between 40 and 60 percent by weight of the total encapsulant composition; and
b) a cycloaliphatic epoxy resin and a methyl-hexa-hydrophthalic anhydride both respectively in an approximate weight range of between 14 and 25 percent by weight of the total encapsulant composition.

17. The silica-filled encapsulant composition in accordance with claim 16, wherein said encapsulant composition has a toughness of approximately between 800 and 2,500 psi-in^{½}.

18. The silica-filled encapsulant composition in accordance with claim 16, including a silane component.

19. The silica-filled encapsulant composition in accordance with claim 16, including 2-ethyl-4-methylimidazole as a catalyst.

20. The silica-filled encapsulant composition in accordance with claim 16, further comprising a wetting agent.

21. A method of encapsulating an integrated circuit chip and a substrate associated therewith, said substrate comprising organic materials, to form a chip carrier, the steps comprising:
applying a silica-filled encapsulant composition to an IC chip and associated substrate, said composition comprising particles having a core material with a glass transition temperature, T_{g,} below room temperature and a core-shell material substantially surrounding said core material, said core-shell material having a T_{g} above room temperature;
curing said encapsulated IC chip and substrate; and
reflowing solder joints between said IC chip and said substrate.

22. The method of encapsulating an integrated circuit chip and a substrate associated therewith in accordance with claim 21, wherein silica fill is in a range of between approximately 40 and 60 percent by weight of the total encapsulant composition.

23. The method of encapsulating an integrated circuit chip and a substrate associated therewith in accordance with claim 21, wherein said encapsulant composition has a toughness of between approximately 800 and 2,500 psi-in^{½}.

24. The method of encapsulating an integrated circuit chip and a substrate associated therewith in accordance with claim 21, including a silane component.

25. The method of encapsulating an integrated circuit chip and a substrate associated therewith in accordance with claim 21, including at least one from the group of epoxy resins, polyimides, cyanide esters, and combinations thereof.

26. The method of encapsulating an integrated circuit chip and a substrate associated therewith in accordance with claim 25, wherein said epoxy resin comprises a cycloaliphatic epoxy resin and/or a glycidyl epoxide resin.

27. The method of encapsulating an integrated circuit chip and a substrate associated therewith in accordance with claim 25, wherein said epoxy resin comprises a cycloaliphatic epoxy resinin an approximate weight range of between 14 and 25 percent by weight of the total encapsulant composition.

28. The method of encapsulating an integrated circuit chip and a substrate associated therewith in accordance with claim 22, wherein said composition comprises a cycloaliphatic epoxy resin in an approximate weight range of between 14 and 25 percent by weight of the total encapsulant composition.

29. The method of encapsulating an integrated circuit chip and a substrate associated therewith in accordance with claim 22, comprising a cycloaliphatic epoxy resin and a methyl-hexa-hydrophthalic anhydride both respectively in an approximate weight range of between 14 and 25 percent by weight of the total encapsulant composition.

30. The method of encapsulating an integrated circuit chip and a substrate associated therewith in accordance with claim 29, including a silane component.
